(19) United States
(12) Patent Application Publication
(10) Pub. No.: US 2003/0038609 A1
(43) Pub. Date: Feb. 27, 2003

(54) High frequency induction motor for use in conjunction with speed control device

(76) Inventor: Lin Chang Shien, Chang City (TW)

Correspondence Address: CHANG-SHIEN LIN, PO BOX 487, Chang-Hua City, 500, TW

(21) Appl. No.: 10/196,941

(22) Filed: Jul. 18, 2002

(30) Foreign Application Priority Data
Aug. 27, 2001 (TW) 090120983

(51) Int. Cl. H02P 1/44

(52) U.S. Cl. 318/751

(57) ABSTRACT

An induction motor is driven by a high frequency alternating current and is provided with a rotor and a stator, which are provided with a conductor winding. The rotor winding is connected with a capacitor to form a resonance loop. The stator winding is provided with the high frequency alternating current to generate a high speed rotating alternating magnetic field. The rotor generates a rotor current via induction and electromagnetic resonance effect, so as to interact with the stator magnetic field to enable the motor to turn, thereby overcoming the friction problem of the conventional ultrasonic motor. The motor of the present invention uses the stator winding or coil to carry out the self-detection of revolution rate. The low frequency enclosure component is taken out by using the voltage or current of the winding. The frequency of the low frequency component is directly proportional to the revolution rate of the motor, so as to serve as the speed control or the speed exhibition. The controller of the induction motor is simplified by the motor speed control device, which is formed of an analog circuit or a digital circuit.

### FIELD OF THE INVENTION

The present invention relates generally to a high frequency induction motor, and more particularly to a contact less high frequency alternating current motor which is realized by means of electromagnetic resonance and magnetic field induction for the purpose of providing a solution to the friction problem of the ultrasonic motors, as well as a speed detection on the basis of the motor stator winding current wave from so as to overcome the deficiencies of the conventional induction motor which is externally connected with a tachometer.

### BACKGROUND OF THE INVENTION

The most primitive motor is the direct current motor, which is provided with carbon brushes and is therefore rather inefficient in view of the carbon brushes that have to be replaced from time to time. The induction motor was introduced at the end of the nineteenth century to replace the DC motor. The induction motor is relatively simple in construction and can be easily maintained. The alternating current induction motor is capable of operating in the ranges of various rotation rates, thanks to the introduction of inverter, which is capable of modulating the high frequency pulse into the low frequency sine wave by means of variable voltage variable frequency (VVVF) in the form of electronic change-over. The high frequency component does not bring about the rotational effect on the induction motor. In light of its exhibition of the low frequency component, the motor is naturally able to affect the low frequency revolution. However, the technique of variable voltage variable frequency involves complicated computation, which accounts for the high price tag of the inverter.

The ultrasonic motor of the twentieth century was the first high frequency alternating motor capable of converting the high frequency alternating current into the mechanical energy in conjunction with the electronic changeover, without having to go through the complicated process of variable voltage variable frequency. As a result, the high frequency alternating motor is capable of an excellent speed control. However, the ultrasonic motor is defective in design in that the rotor and the stator are susceptible to wear which the mechanical friction between the rotor and the stator causes. In addition, the mechanical friction results in the energy consumption, which in turn results in a reduction in the output horsepower. It is therefore necessary to invent a frictionless high frequency alternating current motor, which will no doubt broaden the application of the high frequency alternating current motor.

### SUMMARY OF THE INVENTION

The primary objective of the present invention is to provide a friction-free high frequency alternating current motor, which is made possible by the electromagnetic resonance and the magnetic field induction, so as to overcome the friction deficiency of the conventional ultrasonic motor. The operational principle of the ultrasonic motor works in such a manner that the high frequency alternating current is injected into a piezoelectric material to enable the motor stator to bring about a mechanical resonance capable of effecting a traveling wave. The rotor is caused by the friction force of the traveling wave to turn. In order to solve the problem that is derived from the contact, it is necessary that the magnetic force is used in place of the mechanical force, and that the electromagnetic resonance is used in place of the mechanical resonance. The motor is caused to turn by the action of the contact less force of the magnetic field.

### BRIEF DESCRIPTION OF THE DRAWINGS

FIG. 1 shows a schematic view of a preferred embodiment of the present invention.

FIG. 2 shows a rear view of a rotor of the preferred embodiment of the present invention.

FIG. 3 shows a side view of a rotor of the preferred embodiment of the present invention.

FIG. 4 shows a schematic view of a winding of the rotor of the preferred embodiment of the present invention.

FIG. 5 shows an equivalent circuit of the rotor of the preferred embodiment of the present invention.

FIG. 6 shows a vector view of a polyphase motor operation principle of the present invention.

FIG. 7 shows a vector view of a single-phase motor operation principle of the present invention.

FIG. 8 shows a schematic view of the start-up of the split-phase operation capacitance of the preferred embodiment of the present invention.

FIG. 9 shows a schematic view of the start-up of a changing magnetic pole air gap of the preferred embodiment of the present invention.

FIG. 10 shows a key waveform of the self-detection of the rate of revolution of the present invention.

FIG. 11 shows a self-detection circuit of the preferred embodiment of the present invention.

FIG. 12 shows a block diagram of the speed controller of the present invention.

FIG. 13 shows an analog embodiment of the speed controller of the present invention.

FIG. 14 shows a digital embodiment of the speed controller of the present invention.

FIG. 15 shows a schematic view of the two-phase high frequency alternating current generator of the present invention.

FIG. 16 shows a schematic view of a self-excited high frequency alternating current generator of the present invention.

### DETAILED DESCRIPTION OF THE ENVENTION

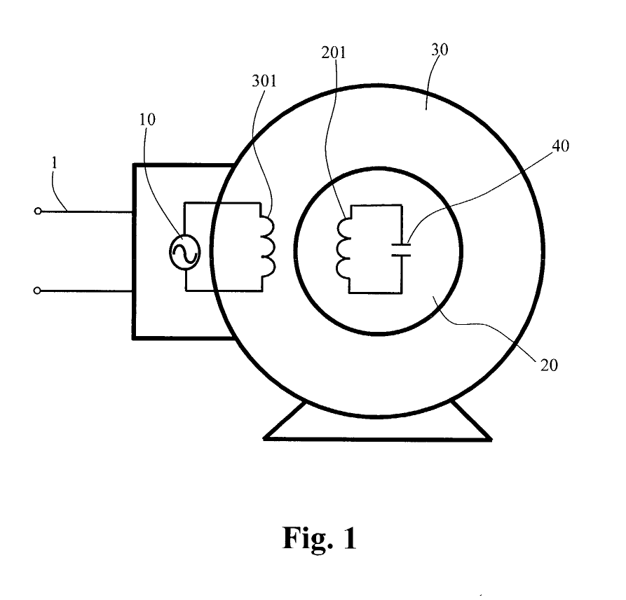

As shown in FIG. 1, the present invention comprises the following component parts.

A high frequency alternating current generator 10 is used to convert the power source 1 into the high frequency alternating current.

A motor stator 30 is provided with a conductor stator winding 301 and an inductor symbol to represent all stator windings 301.

A rotor 20 is provided with a conductor rotor winding 201 and is connected to a capacitor 40 to form an electric inductor-capacitor resonance loop, whose scientific name is resonant tank or resonant tank circuit. The resonant tank is represented by an electric inductor-capacitor loop in FIG. 1.

When the high frequency alternating current is injected into the stator winding 301, there is an alternating magnetic field. Because of the passage of the high frequency alternating current, the stator 30 magnetic fields bring about a rapid change. The change frequency is equal or close to the resonance frequency of the resonant tank, the rotor winding 201 is induced to resonate with the capacitor 40 to effect the resonant current, which influences the rotor 20 magnetic field and reacts with the stator 30 magnetic field, thereby causing the motor to turn.

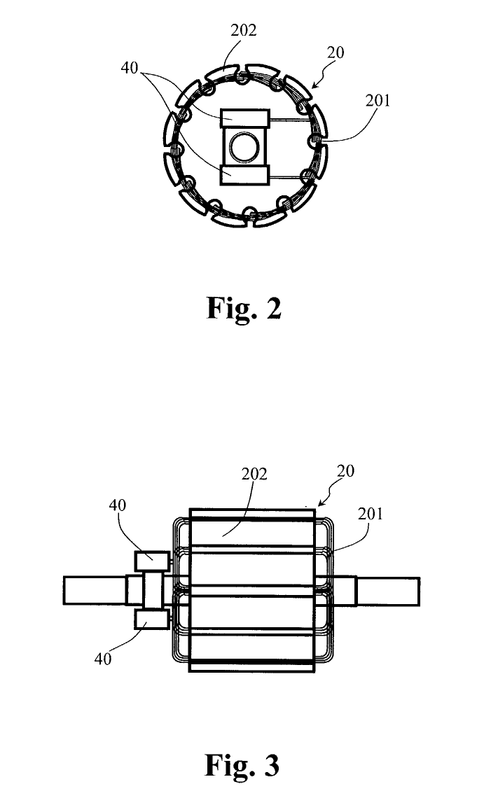

As shown in FIGS. 2 and 3, the present invention uses the resonant tank rotor 20 in place of a squirrel-cage rotor of the conventional induction motor. After the rotor core 202 is wound around the rotor winding 201, two ends of the bonding wire of the rotor winding 201 are connected to the capacitor 40, without the use of the slip ring or commutate to make contact with the stator 30. The rotor winding 201, which is wound on the rotor core 202, is capable of forming the electric inductor. With the addition of the capacitor 40, the foregoing resonant tank circuit is formed.

The rotor 20 may be disposed in the single-phase or polyphase rotor winding 201. Each phase rotor 201 may be connected with one or more capacitors 40, thereby enabling the electromagnetic resonance frequency to be one or more. As there is a plurality of electromagnetic resonance frequencies, each resonance frequency may be used as a suitable frequency width range of the frequency of the high frequency alternating current generator 10. The alternating current frequency that is injected into the stator winding 301 must be equal or close to this electromagnetic resonance frequency.

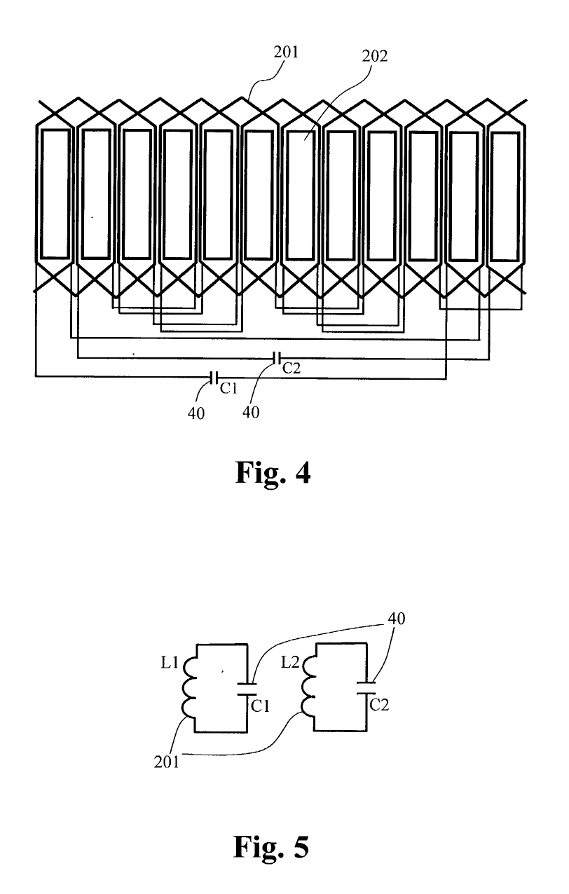

As shown in FIG. 4, the rotor 20 has two phases and six poles. In FIG. 5, two phase's rotor windings 201 are independent and are devoid of electrical contact, with each being connected with a resonant capacitor 40 so as to form two independent resonant loops.

The stator 30 of the present invention is similar in construction to the conventional induction motor stator, with the difference being that the present invention uses a different magnetic material. In light of the motor rotor core 202 and the stator core 302 of the present invention being capable of effecting the high frequency alternating magnetic field, the high frequency magnetic material must be used in place of the silicon steel of the conventional motor, so as to reduce the eddy current loss and the hysteretic loss. The ferrite is commonly used as one of the high frequency core materials.

The rotor core 202 and the stator core 302 of the present invention are not pretreated with a magnetization in which a permanent magnetic field is established. As the stator winding 301 is a single-phase winding at the time when the motor is in operation, it is called a single-phase high frequency induction motor. In case of the polyphase winding, it is called the polyphase high frequency induction motor. As far as the polyphase high frequency induction motors are concerned, two-phase and three-phase high frequency induction motors are commonly used. The two-phase motor comprises less winding and electronic element, whereas the three-phase motor enhances the utilization factor of the core magnetic field.

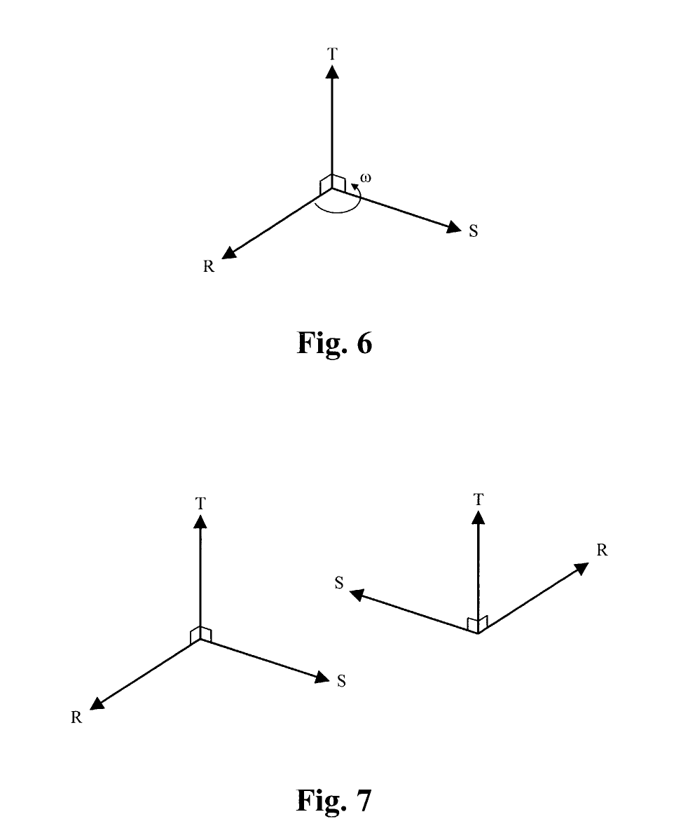

The operational principle of the motor of the present invention is described hereinafter with reference to FIGS. 6 and 7. The induction motor of the present invention is different from the conventional induction motor in design in that the cross-magnetic field of the motor of the present invention revolves at a high speed, and that the cross magnetic field of the conventional induction motor revolves at a relatively slow speed. For this reason, the squirrel-cage rotor of the conventional induction motor is in fact not suitable for use in the magnetic field that revolves at a high speed. In other words, the resonant tank rotor 20 of the present invention is suitable for use in the magnetic field that revolves at a high speed.

As soon as a high frequency alternating current is injected into the stator winding 301 of the present invention, the magnetic field of the stator 30 begins a rapid alternation and a rapid revolution. If the frequency of this alternating current is corresponding to the resonant frequency of the resonant tank of the rotor 20, the rotor winding 201 is induced by the effect of resonance amplification to bring about a maximum current which in turn brings about an alternating magnetic field of the rotor 20. When the direction of the alternating magnetic field of the rotor 20 is normal to the direction of the alternating magnetic field of the stator 30, a maximum rotational force is affected. When the rotor 20 is caused by the resonance to bring about an alternating magnetic field, the phase of the alternating magnetic field is normal to the phase of the alternating magnetic field of the stator 30.

FIG. 6 shows a rotation moment vector view in connection with the principle of the motor operation of the present invention. The vector view is a three-dimensional view. As the magnetic field S of the motor stator 30 is normal to the magnetic field R of the rotor 20, a three-dimensional rotation moment T is effected to enable the motor to turn. The occurrence of the rotation moment T has to do with the angle that is formed between the magnetic field S of the stator 30 and the magnetic field R of the rotor 20, as well as the magnitudes of the magnetic fields S and R. The occurrence of the rotation moment T has nothing to do with the rate of revolution. The magnetic field in high-speed rotation is therefore capable of effecting the rotation moment, which enables the motor to revolve. The single-phase induction motor of the present invention is similar to the conventional single-phase induction motor in such a way that the stator 30 magnetic field is capable of alternating, not revolving. However, as shown in FIG. 7, if the magnetic field of the stator 30 and the rotor 20 are opposite in direction to each other, the direction of the rotation moment remains unchanged. When the magnetic field of the stator 30 is rapidly changed, the magnetic field of the rotor 20 is also rapidly changed in the same phase, thereby bringing about the rotation moments in the same direction to enable the motor to rotate. The single-phase motor of the present invention is similar to the conventional counterpart in design in that the motor is started in an auxiliary manner.

In accordance with the mode by which the motor of the present invention is started, the present invention involves the polyphase motor and the single-phase motor. As far as the polyphase motor of the present invention is concerned, it is different in the starting mode from the conventional polyphase induction motor. When the stator winding 301 is of a polyphase design, the rotor 20 is preferably provided with the polyphase resonant tank. These resonant tanks should be different in resonance frequency, with the difference of the resonance frequencies being small. For example, the rotor 20 is provided with the two-phase winding, with the induction valve or capacitance value of two winding being changed appropriately so as to allow a low frequency of the rotor 20 in operation.

When the stator winding 301 is provided with the alternating current of a phase sequence, the motor is easily enable to turn in the rotational magnetic field direction which is brought about in accordance with the phase sequence. If the rotor 20 is provided with the single-phase winding or only one resonance frequency, the motor can't be started. The motor can be started by a way by which the single-phase induction motor is started.

The single-phase induction motor of the present invention is similar in the start-up mode to the single-phase motor of the prior art and can be started by the split-phase mode. The stator winding 301 is thus divided into a primary winding and an auxiliary winding, which is disconnected upon the completion of start-up by means of a centrifugal switch. If necessary, the auxiliary winding is additionally provided with a start-up capacitor to enhance the split-phase effect. In order to reduce the production cost, the capacitor motors without the centrifugal switch may be adapted in the present invention.

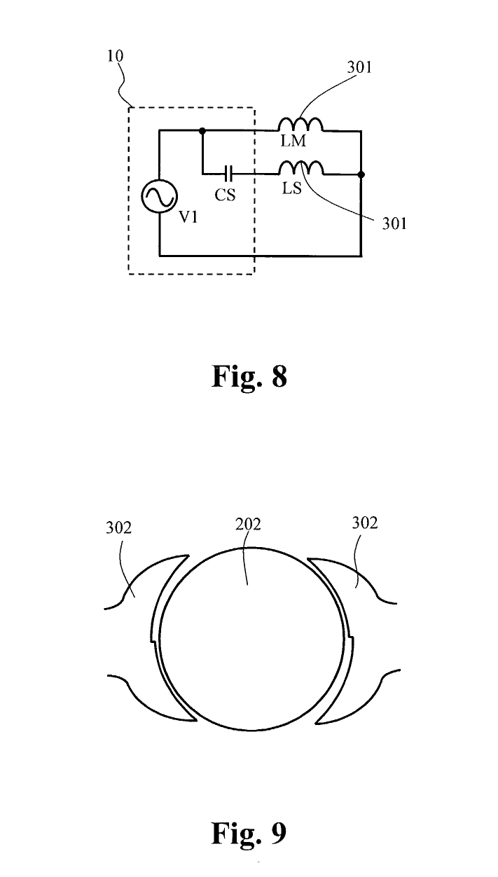

As shown in FIG. 8, the output end of the high frequency alternating current generator 10 is provided with a capacitor motor CS, the stator winding 301 is divided into a primary winding LM, and an auxiliary winding LS, which are wound on the different phases of the stator core 302, In view of the fact that the two windings are different in reactance, and that the capacitor motor CS is involved, the alternating current phases of the primary winding LM and the auxiliary winding LS are different from each other, thereby enabling the capacitor split-phase motor to start and operate in the same way as the polyphase motor. A shading coil may also start the motor of the present invention. The magnetic pole air gap changing method that is used in the motor of the small fan is also suitable for use in the present invention.

As shown in FIG. 8, the magnetic pole air gaps of the rotor core 202 and the stator core 302 become greater in the same rotational direction. This is the changing action of reluctance, which is brought about by the change in the air gap, thereby causing the motor to operate toward one direction in light of the imbalance of reluctance at the time when the motor is started.

The revolution rate of the motor of the present invention is adjusted by changing the magnitude of the high frequency alternating current. The rotor 20 is provided with various currents by various alternating current voltages. The output power of the motor is dependent on the rotor 20 current. For this reason, the revolution rate of the motor can be changed by a method by which the alternating current voltage is adjusted. In practice, the industry makes use of the pulse width modulation (PWM) in place of the voltage amplitude adjustment. On the other hand, if the alternating current frequency is slightly changed, the change in the current magnitude of the rotor 20 can be attained. As a result, the adjustment of the revolution rate of the motor can be achieved by the variable frequency (VF).

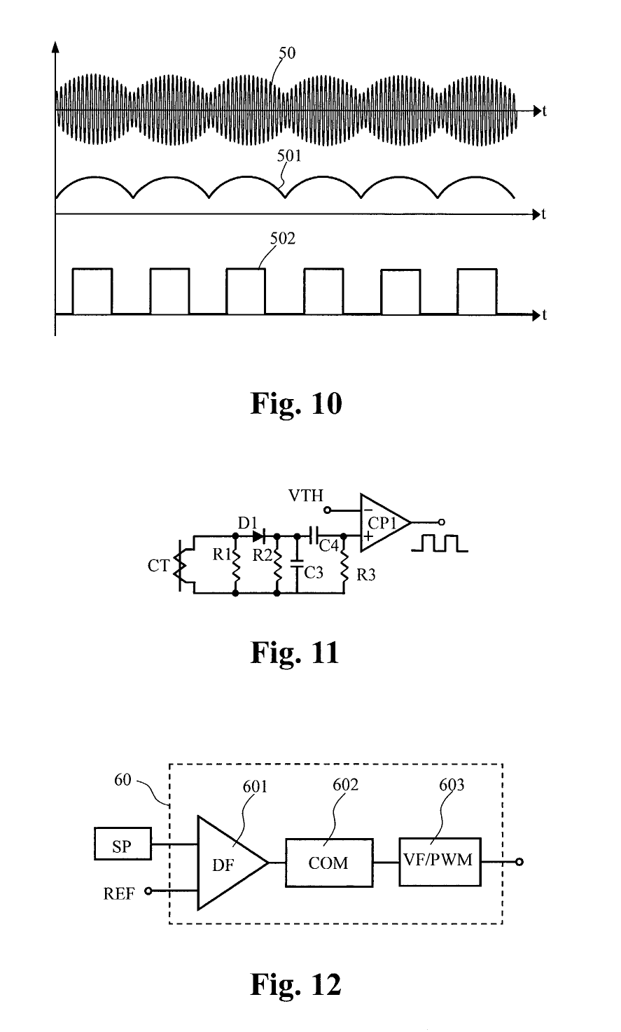

The feature of the present invention is the self-detection of revolution rate of the motor by a simple method, which is described hereinafter with reference to FIG. 10.

When the resonant tanks of the rotor winding 201 turn in various angles, the reactances are various in relations to the stator winding 301. As a result, a low frequency enclosure 501 is formed on a high frequency alternating current wave form 50 of the stator winding 301. The feature of the frequency enclosure 501 is similar to the amplitude modulation (AM). The low frequency enclosure 501 of the wave form 50 is taken out such that its frequency is directly proportional to the revolution rate of the motor. This frequency is converted into a low frequency pulse 502, which is used to exhibit the revolution rate of the motor, or to control the feedback. The detection of a high frequency voltage and a current signal are done by means of current transformer (CT), Hall sensor, high frequency transformer, or resistor and stator winding 301 or coil series, parallel connection or passing over to detect high frequency voltage, current signal.

As shown in FIG. 11, the high frequency alternating current waveform 50 is converted into the low frequency pulse 502. Current transformer detects the current of the stator winding 301. The low frequency enclosure 501 is then filtered out by the low pass filter and converted into the low frequency pulse 502 by the comparator. The high frequency alternating current is divided into the voltage source driving and the current source driving. In the case of the current source driving, the voltage wave form 50 of the stator winding 301 must be detected, with its wave form 50 being the same as that of FIG. 10. In order to facilitate the detecting of the revolution rate, the rotor winding 201 or the stator winding 301 may be the polyphase windings, with its windings arrangement electrical angle being adjusted appropriately without regard to the conventional two-phase arrangement electrical angle of 90 degrees and the conventional three-phase winding arrangement electrical angle of 120 degrees. If necessary, the stator is provided with a revolution detection coil for detecting the rate of revolution of the motor, so as to alleviate the signal interference.

FIG. 12 shows a block diagram of a speed control device 60 of the present invention. The speed control circuit is a portion of the high frequency alternating current generator 10 in a situation in which the speed control of the motor is called for. The detector SP of FIG. 12 may be used to detect the rate of revolution of the stator winding 301 of the present invention. The rate of revolution of the stator winding 301 may be also detected by the conventional method by which a tachometer is added. A differential detector 601 DF is employed to compute the difference between the speed detector SP and the reference revolution rate REF. The difference is fed into the compensator 602 COM to correct the frequency response or to carry out the high level control, such as the fuzzy control. After the difference of rate of revolution is computed and compensated, it is transmitted to the frequency/pulse width modulator 603 to change the high frequency alternating current generator 10 to output the high frequency pulse width or frequency, thereby resulting in the change in revolution rate of the motor. The feedback keeps the revolution rate of the motor in a constant state. In light of the simple control, this control device may be realized by means of analog circuit, digital circuit, or microprocessor.

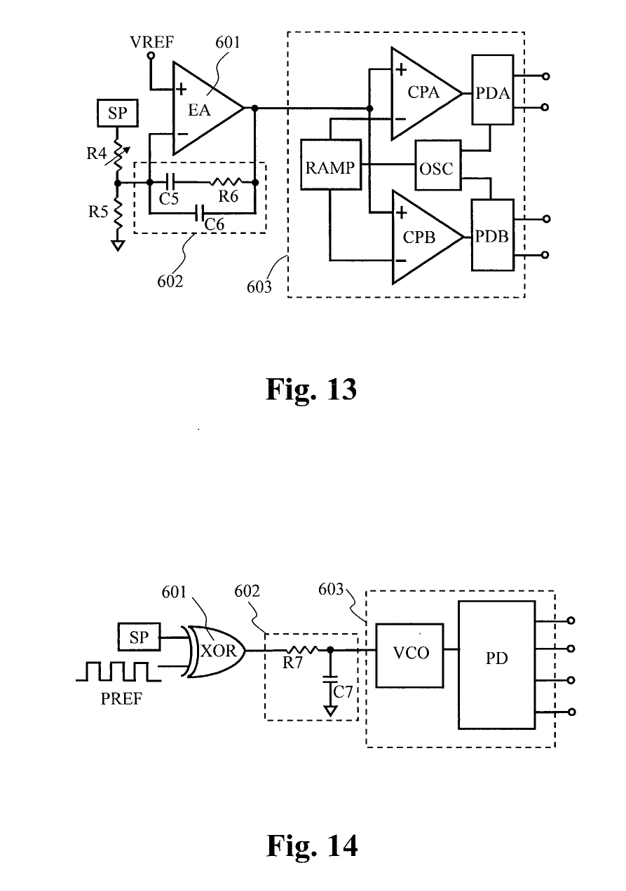

FIG. 13 shows a simple analog speed control device 60 capable of generating four electronic switch control pulse signals, which are required by the two-phase motor. When the speed detector SP transmits an analog voltage signal, the differential detector 601 DF should use an operational amplifier. The reference speed REF is also an analog reference voltage (VREF). The operational amplifier EA calculates the value difference between the speed detector SP and the reference voltage (VREF). The operational amplifier EA is capable of amplification and frequency compensation. The compensator 602 COM of FIG. 13 is added to the operational amplifier EA. A two-phase pulse width modulator 603 is connected to the operational amplifier EA, which is formed of two comparators CPA, CPB, and two pulse distributors PDA, PDB. The negative input ends of the comparators (CPA, CPB) are sawtooth waves brought about by the wave generator RAMP. The two sawtooth wave phase pulse difference is 90 degrees angle, thereby resulting in two-phase pulse. The output voltage of the operational amplifier EA is connected with the positive input ends of the comparators (CPA, CPB) and sawtooth wave to generate the pulse with width in direct proportion to the modulation voltage.

When the motor speed is increased, the voltage detected by the speed detector SP is raised. After the reverse amplification of the value difference of the operational amplifier EA and the reference voltage VREF, the output voltage becomes smaller. The output pulse width of the pulse width modulator 603 decreases. The output pulse width of the high frequency alternating current generator 10 becomes smaller. The motor speed is reduced. The negative feedback enables the motor to maintain the constant speed. Connected after the comparators (CPA, CPB) are pulse distributors (PDA, PDB), which are in fact multiplexers capable of distributing the pulse frequency wave as two set signals to facilitate the driving of two electronic switches of the same phase. The multiplexers enable the pulse frequency to reduce 50%. The oscillator OSC is used to control the sawtooth wave and has oscillator frequency, which is twice the output frequency. If the frequency and the pulse width are changed at the same time, the oscillator OSC must be changed to voltage controlled oscillator VCO whose oscillation frequency changes along with the speed difference voltage.

FIG. 14 shows an embodiment of a simple digital speed control device. When the speed detector SP has an output, which is a digital signal, the differential detector 601 DF should use the exclusive OR, XOR, or phase detector. The reference speed REF is also a digital pulse reference PREF. The phase detector 601 XOR enables the phase or frequency difference of the speed detector SP pulse reference pulse PREF to send out in the form of pulse. The frequency compensation is carried out by the low pass filter 602 (R7-C7) such that a direct current voltage is obtained. Connected after the low pass filter 602 are a frequency modulator 603 which is formed of a voltage control oscillator VCO and a pulse distributor PD, and is capable of generating the pulse of direct proportion along with the magnitude of the input direct current voltage.

When the motor speed increases, the motor frequency detected by the speed detector SP is raised. After the phase detector XOR and the low pass filter 602, the input direct current voltage of the voltage control oscillator VCO increases to enable the frequency of the voltage control oscillator VCO to increase. The output frequency of the high frequency alternating current generator 10 increases. The motor speed is reduced. This negative feedback enables the motor to maintain a constant speed. Connected after the voltage control oscillator VCO is the pulse distributor PD, which is different from FIG. 13 in that the output pulse width of the voltage control oscillator VCO is fixed. Therefore, only one pulse signal is needed to distribute four control signals. The pulse distributor PD is capable of reducing the pulse frequency by 50%. The oscillation frequency of the voltage control oscillator VCO is two times greater than the output frequency. When the output frequency of the speed detector SP is too low, a frequency multiplier is used to raise the frequency.

The high frequency alternating current of the present invention is obtained by converting the power source of the motor. The power source of the motor may be direct current or alternating current. The high frequency alternating current generator 10 further comprises a filter, a rectifier, a power factor correction PFC, a control circuit, and a high frequency inverter. The high frequency alternating current may by a pure alternating current or a direct current containing the high frequency alternating current component. The direct current component has no rotational effect on the motor.

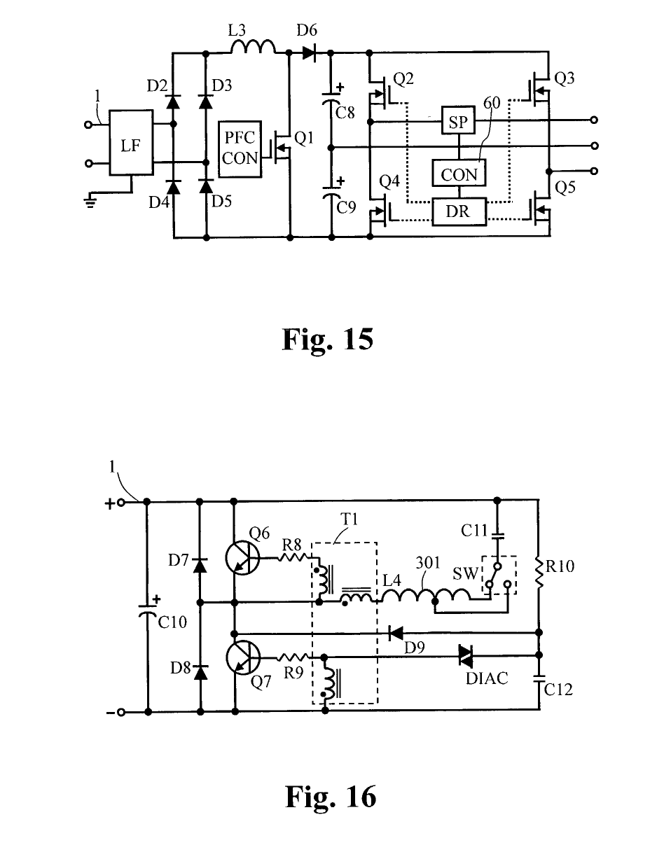

FIG. 15 shows an embodiment of a two-phase high frequency alternating current generator, which comprises a filter LF, a power factor correction PFC, a two-phase high frequency inverter, and a control circuit. A power factor correction control circuit PFCCON controls the power factor correction. The speed detector SP and the speed control device 60 CON of the present invention are connected to the high frequency inverter to control four power MOSFETs. The control signals and the MOSFETs are isolated by the driver DR. The driver DR also amplifies signals. The self-excited mode may be used to generate the high frequency alternating current. However, the self-excited mode is defective in design in that it is difficult to modulate the alternating current voltage or frequency. In view of the fact that the self-excited mode makes use of the power circuit feedback to effect the oscillation, the control circuit is therefore not provided therein with the oscillator, the technique is already applied to the high frequency electronic ballast for fluorescent lamps.

If the high frequency alternating current generator 10 of the present invention is self-excited, the stator winding 301 is provided with a plurality of taps. The different taps generate different reactances similar to the fluorescent lamp electronic ballasts. One mechanical switch is used to change the rate of revolution in a two-way or three-way manner.

FIG. 16 shows an embodiment of the self-excited high frequency alternating current generator. The input power source is the direct current. A single-phase high frequency alternating current is generated via the self-excited serially connected resonance. In light of the absence of the stator 30 auxiliary winding, changing the air gap mode of FIG. 9 starts the motor. The primary winding has section taps capable of two kinds of speed changeover via the switch SW.

What is claimed is:

1. A high frequency induction motor comprising a rotor and a stator, which are provided with a conductor winding, with the motor rotor winding and a capacitor being connected to form an electromagnetic resonant loop, with the stator winding being provided with a high frequency alternating current, the rotor being induced to generate an electromagnetic resonance to interact with said stator to generate a rotation moment enabling said motor to turn.

2. The motor as defined in claim 1, wherein said rotor is made of ferrite and the like; wherein said stator core is made of a magnetic material.

3. The motor as defined in claim 1, wherein said stator winding is provided with an alternating current with a frequency equal or close to the electromagnetic resonant frequency of said rotor.

4. The motor as defined in claim 1, wherein said rotor device is provided with a plurality of capacitors or rotor winding circuits to form a plurality of electric inductors with a plurality resonance frequencies, one of said resonance frequencies capable of being used as the frequency width range of the alternating current connected to the stator winding.

5. The motor as defined in claim 1, wherein the stator is provided with a single-phase winding, the single-phase induction motor being started in an auxiliary mode

6. The motor as defined in claim 5, wherein the auxiliary starting mode is a split-phase start-up.

7. The motor as defined in claim 5, wherein the auxiliary starting mode is an operation capacitor split-phase start-up.

8. The motor as defined in claim 5, wherein the auxiliary starting mode is a shaded-pole start-up.

9. The motor as defined in claim 5, wherein the auxiliary starting mode is a magnetic air gap changing start-up.

10. The motor as defined in claim 1, wherein a plurality of resonance frequencies of the rotor winding are close and not equal for splitting the phase sequence of the stator magnetic field, thereby enabling the rotor to start and operate along the direction of the rotating magnetic field of the stator.

11. The motor as defined in claim 1, wherein the winding is two-phase winding to reduce the winding number and the number of electronic elements.

12. The motor as defined in claim 1, wherein the winding is a three-phase winding to enhance the utilization factor of the core.

13. The motor as defined in claim 1, using individually changed high frequency alternating current pulse width or frequency, and/or simultaneous change in the high frequency alternating current pulse width and frequency to change and control the rate of revolution of the motor.

14. The motor as defined in claim 13, wherein changing the high frequency alternating current amplitude changes the pulse width of the frequency alternating current.

15. The motor as defined in claim 1, wherein changing the reactance of the motor stator-winding loop changes the rate of revolution of the motor.

16. The motor as defined in claim 1, wherein the high frequency alternating current is generated by the self-excited mode of the power circuit feed back oscillation.

17. The motor as defined in claim 1, wherein the high frequency alternating current is generated by the other excited mode of the oscillator added to the control circuit.

18. The motor as defined in claim 1, wherein the high frequency alternating current is generated by the direct current containing the high frequency alternating current component.

19. A self-detection of the rate of revolution of a high frequency induction motor making use of current or voltage signal of a stator winding or a stator revolution detection coil, taking a low frequency enclosure component out of current or voltage signal, the frequency of the low frequency enclosure being directly proportional to revolution rate of the motor for use in speed control or exhibition, with the motor being free of a tachometer.

20. The self-detection as defined in claim 19, wherein the high frequency alternating current is a voltage source, the detection stator winding being current signal.

21. The self-detection as defined in claim 19, wherein the high frequency alternating current is a current source, the detection stator winding being voltage signal.

22. The self-detection as defined in claim 19, wherein the detector is the revolution rate detection coil of the stator, the voltage or current signal of the coil being the revolution rate signal.

23. The self-detection as defined in claim 19, wherein the voltage-current signal is detected by the high frequency transformer, hall detector, high frequency current transformer, or resistor and stator winding.

24. The self-detection as defined in claim 19, wherein the voltage-current signal is detected by the high frequency current transformer, hall detector, high frequency transformer, or resistor and coil series parallel connection or passing over.

25. The self-detection as defined in claim 19, wherein the low frequency enclosure of the high frequency alternating current voltage current is filtered out by a low pass filter, and then using a comparator or a digital gate to convert into a digital pulse.

26. A speed control device of a high frequency induction motor, comprising:
a differential detector for computing the value difference between a speed detector and a difference revolution rate;
a compensator for compensating a frequency response or doing a high-level calculation;
a frequency/pulse width modulator for generating a modulation pulse according to the calculation result.

27. The speed control device as defined in claim 26, wherein the speed detector is a self-detector.

28. The speed control device as defined in claim 26, wherein the speed detector is externally provided.

29. The speed control device as defined in claim 26, wherein the output of the speed detector is an analog voltage signal; wherein the differential detector is an operational amplifier whereby the operational amplifier has a frequency compensating function to replace the compensator.

30. The speed control device as defined in claim 26, wherein the output of the speed detector is a digital pulse signal; wherein the differential detector is exclusive OR, or XOR gate, or phase detector; wherein the compensator is replace by a low pass filter.

31. The speed control device as defined in claim 26, wherein the frequency/pulse width modulator may use a comparator to compare the sawtooth wave and the modulation voltage generating pulse width modulation, using voltage control oscillator to bring about frequency modulation.

32. The speed control device as defined in claim 26, being an analog circuit.

33. The speed control device as defined in claim 26, being a digital circuit.

34. The speed control device as defined in claim 26, being program software of a microprocessor.

35. The speed control device as defined in claim 26, wherein the compensator is provided with a fuzzy control or a neuro-network function for doing a high-level operation.
